(19) United States
(12) Patent Application Publication
(10) Pub. No.: US 2002/0074433 A1
(43) Pub. Date: Jun. 20, 2002

(54) Pressure-controlled injector with high pressure storage injection system

(76) Inventor: Friedrich Boecking, Stuttgart (DE)

Correspondence Address: STRIKER, STRIKER & STENBY, 103 East Neck Road, Huntington, NY, 11743, US

(21) Appl. No.: 10/006,641

(22) Filed: Nov. 8, 2001

(30) Foreign Application Priority Data
Nov. 8, 2000 (DE) 100 55 268.4-13

(51) Int. Cl. F02M 39/00

(52) U.S. Cl. 239/533.3

(57) ABSTRACT

An injector for injecting fuel under high pressure into a combustion chamber of an internal combustion engine has an injector housing, an inlet connectable with a high pressure collecting chamber, a valve body for controlling the inlet from the high pressure collecting chamber and movably received in the housing, a nozzle chamber provided in the housing, a nozzle needle which due to pressure changes in the nozzle chamber can open or close, a sealing spring which biases the nozzle needle, the nozzle needle being provided with pressure stages which are loadable by a hydraulic spring and a pressure acting in the inlet from the high pressure collecting chamber.

### BACKGROUND OF THE INVENTION

The present invention relates a pressure-controlled injector with a high pressure storage injection system.

In direct-injection internal combustion engine nowadays conventionally high pressure storage injection systems are utilized, which contain a high pressure collecting chamber (common rail). In fuel injection systems injection pressure and injection quantity for each operational point of the internal combustion engine can be determined independently from one another, to obtain an additional freedom for the mixture formation. The injection quantity at the beginning of the injection must be dosed so that it is as small as possible, in order to take into consideration the ignition delay between the beginning of the injection and the beginning of the combustion.

German Patent Document DE 197 01 879 A1 discloses a fuel injection device for internal combustion engines. It includes a common high pressure collecting chamber (common rail) which is filled with fuel from a high pressure and connected through injection lines with injection valves extending into the combustion chamber of the internal combustion engine to be supplied with fuel. Its opening and closing movements are controlled correspondingly by an electrically control valve, wherein the control valve is formed as 3/2 -way valve. It connects a high pressure passage which opens into an injection opening of the injection valve with the injection line or a release line. A hydraulic working chamber is provided at the control valve member of the control valve and is controllable in a release passage for adjusting of the adjusting position of the control valve member of the control valve.

Patent document EP 0 657 642 A2 deals with a fuel injection device for internal combustion engine. It includes also a high pressure collecting chamber which is filled through a fuel high pressure by a fuel high pressure pump and from which high pressures branched to the individual injection valves. Control valves for controlling the high pressure injection at the injection valves as well as an additional pressure storage chamber between these control valves and the high pressure chamber are arranged in the individual high pressure lines. For avoiding the presence of the high system pressure always at the injection valves, the control valve is formed so that, during the injection pauses at the injection valve its connection to the pressure storage chamber is closed and the connection between the injection valve and the release chamber is controlled.

### SUMMARY OF THE INVENTION

Accordingly, it is an object of the present invention to provide pressure-controlled injector with high pressure storage injection system which avoids the disadvantages of the prior art.

In keeping with these objects and with others which will become apparent hereinafter, one feature of present invention resides, briefly stated, in a combustion chamber of an internal combustion engine, comprising an injector housing; an inlet connectable with a high pressure collecting chamber; a valve body for controlling said inlet from the high pressure collecting chamber and movably received in said housing; a nozzle chamber provided in said housing; a nozzle needle which due to pressure changes in said nozzle chamber can open or close; a sealing spring which biases said nozzle needle, said nozzle needle being provided with pressure stages which are loadable by a hydraulic spring and a pressure acting in said inlet from the high pressure collecting chamber.

With the inventive injector for injecting fuel the opening behavior of the nozzle needle can be adjusted at the injection nozzle of the injector. Thereby the opening speed of the nozzle needle is adjusted by the selected compensation behavior. With the proposed inventive solution the pressure raising flank which characterizes the course of the building up of the injection pressure can be adjusted by selection of the compensation degree so that, an optimal adaptation to the operational parameter, such as for example the ignition delay of the combustion process in the combustion chamber of an internal combustion engine can be obtained.

The selected solution in construction of a hydraulic spring as well as an additionally provided pressure stage on the nozzle needle on which high pressure acts provide that the opening force which acts on the nozzle needle at the pressure stage and under the seat is influenced so that an abrupt opening after reaching the opening pressure is reliably prevented, so that no excessive injection quantity is supplied into the combustion chamber of the internal combustion engine when there no sufficient flame front is built.

An abrupt opening of the nozzle needle for release of an injection opening which opens into the combustion chamber of an internal combustion engine, to the nozzle tip would mean a fast entry of a large fuel quantity before the start of the combustion. Since however the flame front only after the time interval of the ignition delay can act on this large fuel quantity and thermodynamically converted, an excess of fuel in relatively ″ a combustion chamber before the start of the combustion is highly undesirable. In this way an excess of fuel in the combustion chamber leads to smoking of the internal combustion engine, since the fuel can not be burnt before the flame front is completely formed. A pre-injection with excessively high dose of fuel quantity in a combustion chamber caused by abrupt opening of the needle nozzle has thereby a very damaging effect of smoking of the internal combustion engine which considerably negatively affects the environment by a large emission of soot particles.

With the inventive solution the abrupt opening of the needle nozzle is purposely avoided, so that the needle nozzle when compared to abrupt opening, can be acted upon by producing restoring force to provide a slower opening behavior.

When the needle nozzle has stepped pressure stages, then during abrupt opening of the needle nozzle under the action of high pressure of the nozzle chamber which surrounds the needle nozzle, the occurring forces are counteracted. For this purpose the needle nozzle on the one hand is provided with a surface which forms a part of the limiting surface of the hydraulic spring, and on the other hand is connected with a further pressure stage formed on the needle nozzle not through the hydraulic spring but instead directly through the high pressure which occurs in the high pressure collecting chamber (common rail). The reason is that the needle nozzle at one pressure stage can be loaded with high pressure through a passage which communicates with the nozzle inlet.

For controlling the extension speed of the needle nozzle in the housing of the injector, two pressure levels are available, in particular the pressure which acts in the high pressure collecting chamber (common rail) and the control pressure inside the hydraulic spring chamber, which both produce restoring forces which counter act the opening force of the nozzle needle.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a longitudinal section of an injector with a nozzle needle, having pressure stages which are loaded with high pressure level, in accordance with the present invention; and

FIG. 2 is a view showing hydraulic spring strength cᵢ which is determined by different regulating pressure levels.

### DESCRIPTION OF THE PREFERRED EMBODIMENTS

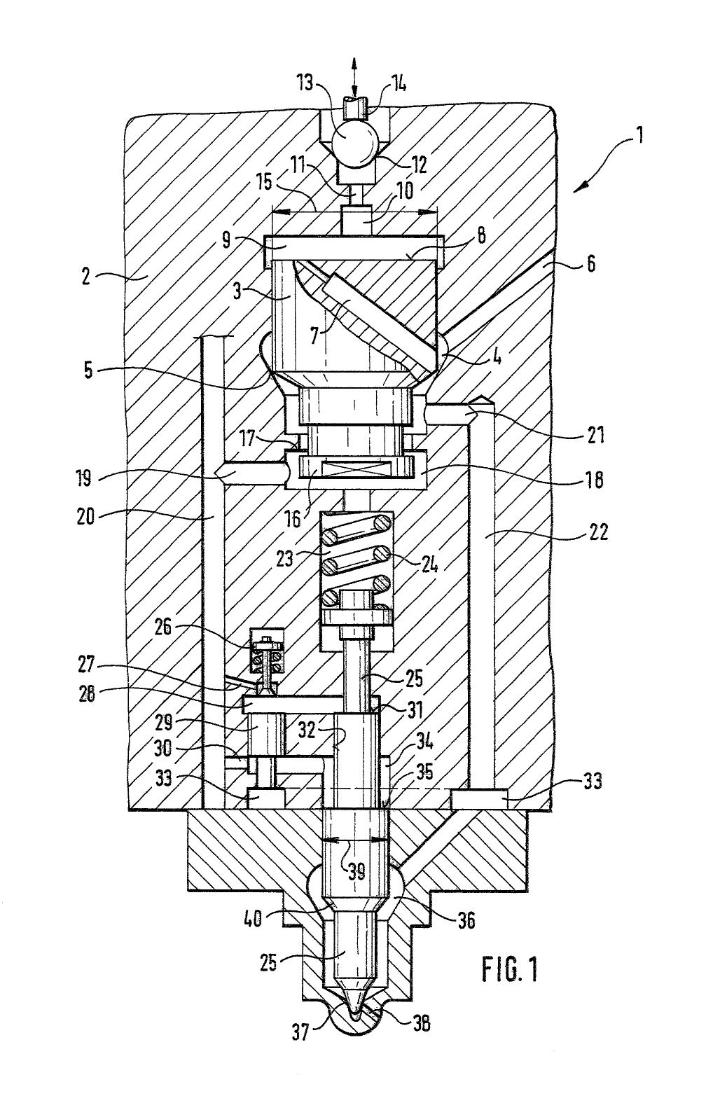

FIG. 1 shows a longitudinal section through an injector with a nozzle needle, whose pressure stages are loaded with high pressure level. The injector 1 has an injector housing 2 which accommodates, independently from one another, a valve body 3 as well as a valve needle 25. An opening is provided in an upper region in the injector housing 2. It opens into a control chamber 9 and the valve body 3 is vertically supported in it. The valve body 3 is surrounded by a valve chamber 4 in a ring-shaped manner. An inlet 6 from a high pressure collecting chamber (common rail) opens into the valve chamber. Through the inlet 6 from the high pressure collecting chamber, fuel under high pressure can fill the valve chamber 4 which surrounds the valve body 3. An inlet nozzle 7 is formed in the valve 3. It opens into the valve chamber 4 on the one hand and is connected with the control chamber 9 on the other hand. In the embodiment of the valve body shown in FIG. 1, the inlet throttle 7 is inclined in the valve body 3.

A sealing seat 5 is formed under the opening of the inlet throttle 7 into the valve chamber 4. The valve body 3 has at the sealing seat 5 a diameter 15 and is seated with it sealingly inside the ring-shaped valve chamber 4 of the injector housing 2. The valve body 3 extends with its end side 8 into the control chamber 9 which is continuously filled with fuel under high pressure through the inlet 6 from the high pressure collecting chamber and through the inlet throttle 7 which communicated with it. It is thereby ensured that always a sufficient controlled volume is produced in the control chamber 9 above the valve body 3.

For producing a vertical movement of the valve body 3 in the opening which is formed in the housing, the control chamber 9 is pressure loaded through a release opening 10 and an outlet throttle 11 connected with it. For this purpose a ball body 13 arranged above a sealing seat 12 is provided and formed in the embodiment of FIG. 1 as a closing element. It is controlled in direction of a double arrow by a not shown in detail schematically illustrated actuating element which is identified with reference numeral 14. When the actuator 14 is pressure unloaded, an extension of the closing body 13 from its sealing seat 12 is performed. Therefore a part of the control chamber volume can be discharged from the control chamber 9 through the release opening 10 and the outlet throttle 11 at the side of a waste oil. With this feature the valve body 3 which is received in the injector housing 2 performs a vertical movement upwardly, so that it opens at the sealing seat 5.

A slider 16 is formed under the sealing seat 5 on the valve body 3. The slider 16 is surrounded by a waste oil chamber 18 which communicates through an upper waste oil branch 19 with a waste oil line 20 formed in the injection housing 2 toward a fuel reservoir. The slider 16 of the valve body 3 cooperates with a control edge 17 formed in the housing. The slider 16 when it set back from the control edge 17 provides a release of the nozzle inlet 22 through the transverse opening 21 at the waste oil side into the waste oil chamber 18 and the upper waste oil branch 19. The slider 16 and the control edge 17 are open when the sealing diameter 15 of the control body 3 moves during a pressure increase in the control chamber 9 to its closing position and thereby the inlet 16 from the high pressure collecting chamber is separated from the nozzle inlet 21, 22.

A hollow chamber 23 is formed in the housing under the waste oil chamber 18 provided in the housing 2. A spiral spring which operates with a sealing spring 24 is received in the hollow chamber 23. It supports at the one hand against the injector housing 2 and at the other hand against a supporting element of a shaft of the needle nozzle 25. The needle nozzle 25 in turn is provided with two pressure stages which are located over one another as considered in a vertical direction of the needle nozzle 25. A ring-shaped cross-sectional surface 31 is formed under a shaft-shaped region of the nozzle needle 25. Further in direction toward the nozzle chamber 36, a ring-shaped surface 35 is formed, starting in the nozzle needle diameter 39 on the nozzle needle 25. The nozzle needle 25 in the region of the nozzle chamber 36 which surrounds it is provided with a pressure stage 40. A narrowing region follows the pressure stage 40 in direction toward the injection opening 38 and extends into a nozzle seat diameter 37. An injection opening 38 which extends into the combustion chamber of an internal combustion engine is closed in the seat 37. It is controlled by controlling the nozzle needle 25 due to pressure loading of the nozzle chamber 36 with high pressure in the transverse opening 21 and in the nozzle inlet 22 in a vertical direction upwardly, against the action of the sealing spring 24.

A hydraulic spring chamber 24 is formed in the injector housing 2 of the injector shown in FIG. 1. The spring chamber 28 ideally is loaded by adjusted leakage along the nozzle needle guide 32 in the injector housing 2 with its control volume. As shown in FIG. 1, a refilling valve 26 is associated with the hydraulic spring chamber 28. The refilling valve 26 can be formed for example as a thrust valve whose plate-shaped closing surface forms a part of the wall of the hydraulic spring chamber 28. During pressure loading via a control piston 29 as well as the cross-sectional surface 21 provided on the nozzle needle, it is pressed in its seat, so that a central waste oil branch 27 to the waste oil line 20 to the fuel reservoir is sufficiently closed.

In addition to the plate-shaped closing element of the refilling valve 26 and also the transverse surface 31 formed on the nozzle needle 25, the upper end surface of a control valve 29 is also loaded by volumes received in the hydraulic spring chamber 28. The control piston 29 is arranged parallel to the nozzle needle 25 in the injector housing 2 and at its upper end side is loaded with fuel volumes received in the hydraulic spring chamber 28. At the side of the control valve which is opposite to the upper end side of the control valve 39, it is provided with a pin-shaped element which extends into a connection of the connecting passage 33 which is formed for example as a ring-shaped groove, arranged inside the injector housing 2 and branched from the nozzle inlet 22. The connection passage 33 which is formed for example as a ring-shaped groove in the injector housing provides under the control piston 29 the high pressure from the high pressure collecting chamber which acts in the nozzle inlet 21, 22, when the valve body 3 during unloading of the control chamber 9 releases the inlet 6 from the high pressure collecting chamber and fuel under high pressure enters into the nozzle chamber 36.

From the ring-shaped groove 33, the pressure acts along the pin which is formed on the control piston 29 in a ring chamber 34 inside the injector housing 2. It is located opposite to the above mentioned ring-shaped surface 35, and extends in the nozzle needle diameter 39. Thereby an upper pressure stage 31 which is loaded with the volume of the hydraulic spring 23 is formed on the nozzle needle 25, as well as a ring-shaped surface 35 which is loaded with a high pressure through the ring shaped groove 33 via the high pressure acting in the ring chamber 34. The vertical extension movement of the nozzle needle 25 is provided during loading of the nozzle chamber 35 with a fuel under high pressure, through the pressure stage 40 formed on the nozzle needle 25.

Restoring forces which are produced with different pressure level by the extension movement of the nozzle needle 25 produced through the pressure stage 40 of the nozzle needle 25 due to the pressure loading of the cross-sectional area surface 21 as well as the ring-shaped surface 35. They are dimensioned so that an abrupt opening of the nozzle needle 25 during loading of the nozzle chamber 36 through the transverse opening 21 and the nozzle inlet 22 with fuel under high pressure is excluded. Moreover, with the corresponding selection of the control volumes as well as the cross-sectional surface 21 and the corresponding dimensioning of the ring-shaped surface 35 in the needle nozzle 25 a progressive extension of the nozzle needle 25 is achieved after reaching the opening pressure. Therefore it is ensured that with a pre-injection which precedes a main injection the fuel volumes which correspond the preinjection is injected into the combustion chamber of the internal combustion engine through the injection opening 38.

The operation of the injector shown in FIG. 1 for injection of fuel under high pressure and to the combustion chamber of an internal combustion engine is as follows:

When the actuator 14 is controlled, a pressure change occurs in the control chamber 9 by outflow of a partial volume of the fuel volume under pressure which is contained in the control chamber 9. The end surface 8 of the valve body 3 moves into the control chamber 9, opens at the sealing seat 5, so that the inlet 6 from the high pressure collecting chamber is loaded through the transverse opening 21 in the nozzle inlet 22 and the nozzle chamber 36 with fuel under high pressure. Due to the pressure stage 40 of the nozzle needle located in the control chamber 36, an opening force acts on the nozzle needle 25 of the injection nozzle and it moves in a vertical direction upwardly. The valve body 3 which moves upwardly in the opening in the injector housing 2 closes the transverse opening 21 and the nozzle inlet 22 from waste oil 18, 19, and 20, since its slider 16 overlaps the control edge 17 provided in the housing and separates the inlet 6 from the high pressure collecting chamber (common rail) from waste oil.

Restoring forces on the nozzle needle 25 counteract the opening force produced upwardly through the pressure stage 40 in the nozzle chamber 46 and thereby the moving out of the nozzle needle tip from the seat 37. Fuel volumes contained in the hydraulic spring chamber 28 act on the cross-sectional surface 31 as damping volumes, which load the cross-sectional surface 31 of the nozzle needle on the first pressure stage. Moreover, the high pressure at the ring-shaped surface 35 of the nozzle needle 25 with a diameter 39 is transmitted through the ring-shaped groove 33 in the injector housing 2 from the nozzle inlet 22 with the closed slider 16 at the valve body 3 and open sealing seat 5 at the valve body 3. A compensation between the pressures in the hydraulic spring chamber 28 as well as the high pressure in the ring chamber 35 and in the connecting passage 33 which is formed as a ring-shaped groove takes place through the movable piston which is formed as a control piston 29. This makes possible to equalize the pressure differences between both damping volumes by differently dimensioned end surfaces. The surface of the control piston 29 which faces the high pressure acting in the connecting passage 33 is smaller than that at the side of the control piston 29 which extends into the hydraulic spring chamber 28.

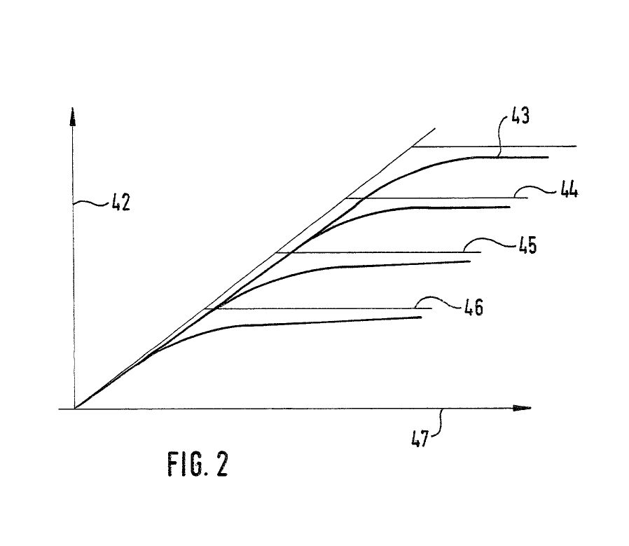

FIG. 2 shows hydraulic spring rigidities cᵢ which are determined by different control levels.

The course of the spring opening force 42 shown in FIG. 2 represents the force which acts on the nozzle needle 25 under its seat. Reference numerals 44, 45 and 46 identified constant control pressures, to which corresponding asymptotically extending spring rigidities slowly approach. The different control levels 44, 45 and 46 obtained by a corresponding configuration of transverse surface 31 as well as ring-shaped surface 35 in the nozzle needle 25. Also control volumes which exist in the hydraulic spring chamber 28 as well as in the ring chamber which surrounds the nozzle needle 25 is important. With the design of the cross-sectional surface 31 as well as the ring-shaped surface 35 on the nozzle needle 29 in a diameter 39, the conditions can be taken into consideration, that in the ring chamber 34 different pressure levels which act in the high pressure collecting chamber (common rail) are produced through the inlet 6 from the high pressure collecting chamber through the transverse opening 21, the nozzle inlet 22 and the connecting passage 33. Depending on the dimensions of the end surfaces of the control piston 39, one of which is arranged opposite to the hydraulic spring chamber 28 and another with an end surface formed with smaller effective surface is located at opposite to the high pressure collecting chamber, the corresponding control pressure 44, 45, 46 can be determined to the corresponding favorable level.

It will be understood that each of the elements described above, or two or more together, may also find a useful application in other types of constructions differing from the types described above.

While the invention has been illustrated and described as embodied in pressure-controlled injector with high pressure storage injection system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An injector for injecting fuel under high pressure into a combustion chamber of an internal combustion engine, comprising an injector housing; an inlet connectable with a high pressure collecting chamber; a valve body for controlling said inlet from the high pressure collecting chamber and movably received in said housing; a nozzle chamber provided in said housing; a nozzle needle which due to pressure changes in said nozzle chamber can open or close; a sealing spring which biases said nozzle needle, said nozzle needle being provided with pressure stages which are loadable by a hydraulic spring and a pressure acting in said inlet from the high pressure collecting chamber.

2. An injector as defined in claim 1; and further comprising means forming a high pressure side; a ring chamber surrounding said nozzle needle; and a connection formed in said housing between said high pressure side and said ring chamber.

3. An injector as defined in claim 1, wherein said connection is formed as a circumferential ring-shaped groove provided in said housing.

4. An injector as defined in claim 2, wherein said nozzle needle has a ring-shaped surface which is loaded with high pressure through said connection between said high pressure side and said ring chamber.

5. An injector as defined in claim 1; and further comprising a hydraulic spring chamber, said nozzle needle having a transverse surface arranged so that above said transverse surface of said nozzle needle control volumes which are contained in said hydraulic spring chamber act as a force directed opposite to an opening force of said nozzle needle.

6. An injector as defined in claim 1; and further comprising a refilling valve associated with said hydraulic spring chamber.

7. An injector as defined in claim 1; and further comprising a control piston which is arranged in said housing parallel to said nozzle needle, said hydraulic piston having an end surface which is loaded by a control volume of a hydraulic spring chamber and through a connection with high pressure.

8. An injector as defined in claim 1; and further comprising a valve body which is separate from said nozzle needle and formed as a slider which releases a nozzle inlet to a waste oil side.

9. An injector as defined in claim 1; and further comprising means forming restoring forces which counteract an opening force acting on said nozzle needle when high pressure acts on said pressure stage, such that said restoring forces are produced by a pressure loading of a cross-sectional surface through a hydraulic spring chamber and through pressure which is produced on a ring-shaped surface of said nozzle needle with interposition of end surfaces of a control piston.

10. An injector as defined in claim 1; and further comprising a nozzle guide in said housing; and a hydraulic spring chamber which is filled by a leakage along said nozzle guide.
